(19) United States
(12) Patent Application Publication
(10) Pub. No.: US 2008/0282014 A1
(43) Pub. Date: Nov. 13, 2008

(54) Card reading apparatus for multi-directional data transmission

(76) Inventors: Chih Kang Pan, Taipei City (TW); Yao-Shun Hung, Taipei City (TW); Hsiang-Chi Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/798,191

(22) Filed: May 11, 2007

(51) Int. Cl. G06F 13/20

(52) U.S. Cl. 710/313

(57) ABSTRACT

A card reading apparatus for multi-directional data transmission is provided, including a USB interface, a memory card interface, an ATA/ATAPI interface, and a USB OTG controller. The USB OTG controller is connected to the USB interface, the memory card interface, and the ATA/ATAPI interface so that the USB media device connected to the USB interface, the flash memory cards connected to the memory card interface, and the data storage devices, such as hard disk and CD-R/W, connected to the ATA/ATAPI interface can all perform multi-directional data transfer among themselves.

### BACKGROUND OF THE INVENTION

1. Field of the Invention

The present invention relates to a card reading apparatus for multi-directional data transmission and, more particularly, to a flash memory card reading apparatus connectable to data storage for multi-directional data transmission, data storage, and application functions.

2. The Related Arts

The conventional USB on-the-go (OTG) devices, such as data bank, usually include one or two USB ports for connecting to USB devices, and use an IDE port for connecting a hard disk so that the data in the USB device connected to the USB port, such as portable disk, can be copied to the hard disk for storage. In addition, most card readers, such as interfaces for SD memory card, multi-media card (MMC), and memory stick card, only support one-way data copying. That is copying the data in the flash memory card to the hard disk.

The conventional USB OTG devices usually do not support the reversed data transfer, for example, copying the data in the hard disk or the flash memory connected with the card reader to the USB devices. To accomplish this, a desktop personal computer or a notebook computer is usually required to perform the data transfer from the hard disk or the flash memory card connected with the card readers. It is inconvenient and time-consuming for the users.

The above conventional USB OTG devices usually only support a few types of memory card interfaces and one-way data copying, and thus the usability is limited. This also restricts the usability of USB devices, such as portable disks.

### SUMMARY OF THE INVENTION

The present invention has been made to overcome the above drawbacks of the conventional card reading apparatus. The primary object of the present invention is to provide a card reading apparatus for multi-directional data transmission, comprising a USB interface, a memory card interface, an ATA/ATAPI interface, and a USB OTG controller. The USB OTG controller is connected to the USB interface, the memory card interface, and the ATA/ATAPI interface so that the USB media device connected to the USB interface, the flash memory cards connected to the memory card interface, and the data storage devices, such as hard disk and CD-R/W, connected to the ATA/ATAPI interface can all perform multi-directional data transfer among themselves.

The main feature of the card reading apparatus for multi-directional data transmission is that the present invention can be used with a variety of data storage devices, such as portable disk, hard disk and flash memory cards, to provide data transmission, storage, and application functions without using a personal computer or notebook computer.

These and other objects, features and advantages of the invention will be apparent to those skilled in the art, from a reading of the following brief description of the drawings, the detailed description of the preferred embodiments, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a system function block diagram of a first embodiment of the present invention; and

FIG. 2 is a system function block diagram of a second embodiment of the present invention.

### DETAILED DESCRIPTION OF THE PREFERRED EMBODIMENTS

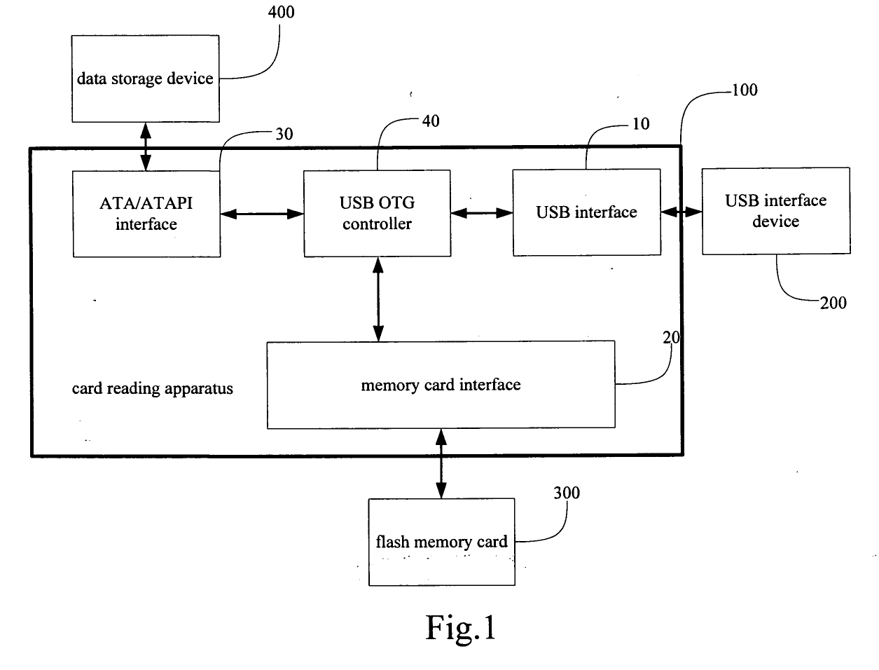

With reference to the drawings and in particular to FIG. 1, which shows a system functional block diagram in accordance with a first embodiment of the present invention, a card reading apparatus 100 comprises a USB interface 10, a memory card interface 20, an ATA/ATAPI interface 30, and a USB OTG controller 40. The USB interface 10 provides connection to a USB interface device 200. The USB interface 200 is not limited to any specific type. The present invention uses a portable disk as an embodiment for explanation. Other USB interface devices, such as digital camera, mobile phone, MP3 player, digital video camera, PDA, and recording pen, are also within the scope of the present invention.

The memory card interface 20 provides connection to a flash memory card 300. The flash memory card 300 is not limited to any specific type. The present invention uses an SD flash memory card as an embodiment for explanation. Other flash memory cards, such as MMC, CF, SM, and XD-Picture, are also within the scope of the present invention.

The ATA/ATAPI interface 30 provides connection to a data storage device 400. The data storage device 400 is not limited to any specific type. The present invention uses a hard disk as an embodiment for explanation. Other data storage devices, such as CD-RW, are also within the scope of the present invention.

The USB OTG controller 40 is connected to the USB interface 10, the memory card interface 20, and the ATA/ATAPI interface 30. The USB OTG controller 40 provides bi-directional data transmission, storage, and application functions for at least two different data media. Therefore, the USB interface device 200 connected to the USB interface 10, the flash memory card 300 connected to the memory card interface 20, and the data storage device 400 connected to the ATA/ATAPI interface 30 can perform multi-directional data transmission, storage, and application functions under the control of the USB OTG controller 40. For example, the data stored in the flash memory card 300 connected to the memory card interface 20 can be transmitted to the USB interface device 200 connected to the USB interface 10 for storage or application. Similarly, the data stored in the data storage device 400 connected to the ATA/ATAPI interface 30 can be transmitted to the flash memory card 300 connected to the memory card interface 20 for storage or application, and then the data can further be transmitted from the flash memory card 300 connected to the memory card interface 20 to the USB interface device 200 connected to the USB interface 10 for further storage or application. The transmission path is not limited to any specific route. Other transmission path, storage, and application functions are also within the scope of the present invention.

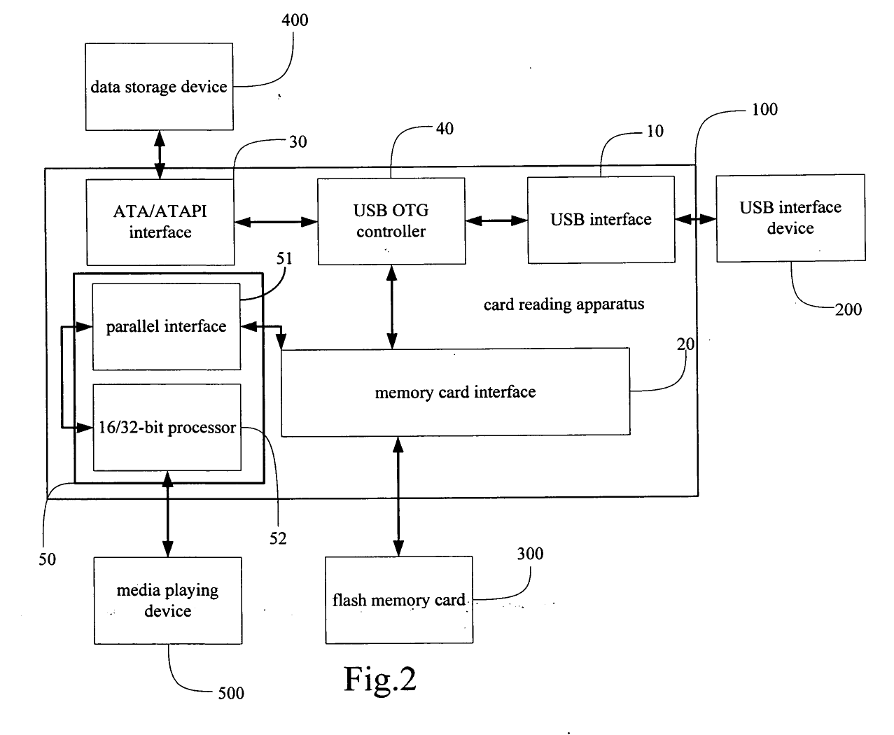

FIG. 2 shows a system functional block diagram in accordance with a second embodiment of the present invention, where the memory card interface 20 is connected to a parallel interface module 50. The parallel interface module 50 comprises a parallel interface 51 and a 16/32-bit processor 52. The parallel interface 51 is connected to the memory card interface 20, and the 16/32-bit processor 52 is connected to a media playing device 500. The media playing device 500 is not limited to any specific type. The present invention uses a digital TV as an embodiment for explanation. Other media playing devices, such as DVD player, MP3 player, and 3G mobile phone, are also within the scope of the present invention.

The media playing device 500 can use the data transmission, storage, and application function among the USB interface device 200 connected to the USB interface 10, the flash memory card 300 connected to the memory card interface 20, and the data storage device 400 connected to the ATA/ATAPI interface 30 to play and apply the media data stored in the USB interface device 200, the flash memory card 300, and the data storage device 400.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A card reading apparatus for multi-directional data transmission, comprising:
a USB interface, connecting a USB interface device;
a memory card interface, connecting a flash memory card;
an ATA/ATAPI interface, connecting a data storage device; and
a USB controller; connecting the USB interface, the memory card interface, and the ATA/ATAPI interface for providing multi-directional data transmission, storage, and application among the USB interface device connected to the USB interface, the flash memory card connected to the memory card interface, and the data storage device connected to the ATA/ATAPI interface.

2. The apparatus as claimed in claim 1, wherein the USB interface is connected to a portable disk.

3. The apparatus as claimed in claim 1, wherein the memory card interface is connected to an SD flash memory card.

4. The apparatus as claimed in claim 1, wherein the memory card interface is connected to a parallel interface module.

5. The apparatus as claimed in claim 4, wherein the parallel interface module further comprises:
an interface module, connecting to the memory card interface; and
a 16/32-bit processor, connecting to a media playing device.

6. The apparatus as claimed in claim 5, wherein the 16/32-bit processor is connected to a digital TV.

7. The apparatus as claimed in claim 1, wherein the ATA/ATAPI interface is connected to a hard disk.
